(19) United States
(12) Patent Application Publication
(10) Pub. No.: US 2014/0266001 A1
(43) Pub. Date: Sep. 18, 2014

(54) SOLAR POWER BOX

(71) Applicant: Nancy K. Wilde, Vernon (CA)

(72) Inventor: Nancy K. Wilde, Vernon (CA)

(21) Appl. No.: 14/208,594

(22) Filed: Mar. 13, 2014

Related U.S. Application Data
(60) Provisional application No. 61/783,414, filed on Mar. 14, 2013.

(51) Int. Cl. H02J 7/35

(52) U.S. Cl. CPC H02J 7/355
USPC 320/101

(57) ABSTRACT

A toolbox is disclosed that provides power via 12-volt DC, 110-volt AC, and USB outlets that includes a solar panel for electrical energy generation. The preferred embodiment of the toolbox is configured for installation on a vehicle and can also be charged via the vehicle's inverter or via a common 110-volt AC power supply.

### RELATED APPLICATION

The present application claims the benefit of U.S. Provisional Application No. 61/783,414 filed Mar. 14, 2013, which is incorporated herein in its entirety by reference.

### FIELD OF THE INVENTION

The present invention relates in general to a vehicle-mounted tool box having stored 110-volt and 12-volt power with access to that stored power via 110-volt plug ins, a 12-volt plug in, and USB ports. The batteries are charged via solar panels, vehicle alternator, or inverter charger plugged in to house outlet.

### BACKGROUND OF THE INVENTION

Pickup trucks are used in conjunction with outdoor work and recreation. Objects requiring a power source are often used outside in an environment where electric power is not available. Using extension cords can be inconvenient or totally not possible due to the proximity of an external power source. The battery powered truck tool box allows access to a readily available source of electrical power to run/charge lap tops, cell phones, cameras as well as power larger equipment like circular saws, pancake compressors, radios, table saws, construction and camping equipment as examples.

### SUMMARY OF THE INVENTION

This invention introduces a typical pickup truck aluminum tool storage box and method which do not require access to a conventional 110-volt AC wall outlet. The apparatus and method of the present invention provides three different ways to collect, store and convert energy to an AC and DC voltage.

The first way to collect energy is a solar energy collection device horizontally mounted on the top of the lid of the tool box collecting and converting solar energy to an electrical DC voltage. It sends the energy to a base station mounted inside the tool box.

The second way to collect energy is with the truck alternator sending power to the trailer wiring harness tow package plug connector. A standard trailer wiring harness plug connector is located at the trailer hitch. At the trailer hitch connection a standard 6-pin power cable is plugged in and the other end of the cable is plugged into a receptacle installed on the left exterior of the tool box. The 6-pin connector cable is a standard power cable used on any towed trailer. The energy collected this way is sent to a base station mounted inside the tool box.

The third way is by using a standard extension cord the tool box can be plugged into a 110-volt outlet found on the exterior of a house or shop. There is an exterior mounted plug-in on the right side of the tool box exterior. The energy collected this way is sent to a base station mounted inside the tool box.

In one embodiment of the present invention, the base station is housed inside the tool box. It consists of one or more 220 Ah 12-volt batteries, 2000 watt pure sine inverter, solar charge controller and breaker panel.

The tool box is divided into sections with the right hand section housing the 220 Ah 12-volt batteries; the central section is empty and available for tool storage and the left hand section housing the breakers, fuses and the 2000 watt inverter charger. The batteries store the collected 12-volt DC energy and the inverter/charger converts the DC voltage to AC voltage. Power outlet plug-ins mounted in various positions on the tool box, both internally and with external access, receive 110-volt AC power from the inverter or 12-volt DC power direct from the batteries. This allows an electrical device to be plugged into the desired terminal for power.

The tool box construction style is such that the tool box protrudes over the pickup truck bed rails slightly. This allows the tool box to rest on the truck bed rails and allow space under the tool box. The tool box is fastened to the truck box by screwing through the tool box and the railing in this location. The protruding part of the tool box 1 on both sides houses the 110-volt and the USB port plug-ins. Access to these plug ins from the outside is from a locking metal flap that drops down exposing a small chamber housing these various plug ins. As well, the inverter control switch panel is located in the left side chamber and the battery charge level indicator panel is located in the right side chamber.

An aspect of an embodiment of the invention provides electricity to external electrical devices from solar energy collected from energy collection devices located on the top of the tool box lid.

A further aspect of an embodiment of the invention provides a power switch that can disconnect the inverter of the base station in the event of an emergency or no further need for power.

An aspect of an embodiment of the invention provides the option of using an external power source to charge the batteries.

Additional aspect objective features and advantages of the present invention will become apparent from the following description of the preferred embodiment with reference to the attached drawings.

### BRIEF DESCRIPTION OF THE DRAWINGS

FIG. 1 is a perspective view of the tool box and solar collection device;

FIG. 2 is a front view of the tool box including;

FIG. 3 is left side (driver's side) end view of tool box

FIG. 4 is the right side (passenger side) end view of the tool box;

FIG. 5 is the top external view of the tool box;

FIG. 6 is the internal wiring diagram for the electrical system of the tool box; and

FIG. 7 is the wiring schedule of the electrical system of the tool box.

### DETAILED DESCRIPTION OF THE DRAWINGS

The following is a schedule of identifiers used in this description:
1. Tool box
2. Solar panel
3. Venting
4. 110-volt power plug in
5. 12-volt DC power plug in from trailer harness plug in (truck alternator)
6. Handle/lock
7. Tool box lid
8. Exterior access flap
9. Exterior access flap latch
10. 110-volt GFI plug in
11. USB port plug in
12. Inverter/charger control panel
13. Solar charge/battery level indicator
14. Interior tool box compartment divider
15. Battery
16. Inverter/charger
17. Fuse box
18. 60 amp breaker
19. 20 amp 110-volt breaker
20. 400 amp fuse
21. Ground to tool box
22. Ground
23. Hinge
24. 12-volt plug in
25. Isolator

FIG. 1 is a perspective view of the pickup truck tool box and the solar energy collection device 2 of one embodiment of the present invention that converts solar energy to an electrical DC voltage charge. The pickup truck tool box shown in FIG. 1 could be considered a conventional style of pickup truck tool box however the style of the tool box can be configured in different ways such as gull wing or as a standard box without protruding ends. The tool box can be constructed of aluminum or steel or plastic as long as it is capable of supporting the internal devices. The solar energy device is groups of solar cells in the form of a panel 2 designed to absorb the sun's rays as a source of energy for generating electricity. The panel 2 is positioned on the top of the pickup truck tool box to receive maximum exposure to the sun. The panel 2 is riveted directly to the top of the tool box. Optionally, the tool box can include a protective cover over the solar panel 2, such as a grate made of metal or plastic or a plexiglass cover. The interior of the tool box houses the electrical charging/storage base station and is protected from the weather. All electrical connections and components are housed in the interior of the tool box.

FIG. 2 is a perspective view of the front of the tool box including the 110-volt charging plug in 4 and the 6-pin trailer wiring plug 5 in as well as the venting 3. The venting 3 is positioned in such a way as to provide air circulation and cooling for the inverter/charger 16.

FIG. 3 is a perspective left side view (driver's side) of the pickup truck tool box 1 including the drop down access flap 8, external venting 3 for the inverter/charger 16, 110-volt plug in location 10, USB port location 11, and inverter/charger control panel 13. The inverter/charger control panel 13 activates the inverter 16 (on/off) and as well manages various functions of the inverter 16. An inverter 16 takes 12-volt DC energy and converts it to 110-volt AC energy. The inverter/charger control panel switch 12 also activates the charging capabilities of the tool box 1 when either the 110-volt external plug in 4 or 6-pin trailer harness wiring 5 is being used. The charger aspect of the inverter 16 allows external 110-volt power from a house or shop plug in to be used to recharge the truck tool box batteries 15. The inverter/charger control panel 13 is LED light indicating.

FIG. 4 is a perspective right side view (passenger side) of the pickup truck tool box 1 including the drop down access flap 8, 110-volt plug in location 10, USB port location 11 and battery charge level indicator panel 13. The battery charge level indicator panel 13 displays the energy collection device charging current or state of current charge or rate of current charge or a current discharge. The battery charge level panel may be LED, or LCD or a light indicator depicting the level of charge in the batteries.

FIG. 5 is a perspective top view of the pick truck tool box 1 showing solar collector panels 2.

FIG. 6 is the wiring schedule of the pickup truck tool box 1. This electrical system provides power to electrical devices requiring an AC 110-volt terminal 10, DC 12-volt terminals 24, or 12-volt USB terminals 11. The electrical system is housed in the left and right sections inside the pickup truck tool box 1. In the event of servicing or repair, opening the tool box lid 7 will provide access to the electrical system components and inverter/charger 16. In use, the solar collection device 2 collects energy from the sun and converts the energy into an electrical charge that is stored in the batteries 15. The battery charge controller 13 maintains the proper charging voltage for the batteries 15. The batteries 15 store the energy provided by the solar panel 2, truck wiring harness, or the external 110-volt charge. The stored energy is regulated by the battery charge controller 12 to the 12-volt deep cycle gel batteries 15 which sends 12-volt DC to a power inverter 16. The pure sine wave power inverter 16 converts a DC voltage output from the storage battery 15 to 110-volt AC. The 12-volt DC power terminals 24 are supplied by power direct from the batteries 15. The power outlets are terminals which allow 110-volt AC powered devices to access the output of the pure sine wave power inverter 16. The battery charge controller 13 maintains the proper charging voltage for the batteries 15. The batteries 15 store the energy provided by the solar panels 2. The control system features fusible links and breakers which allow electrical current to pass through the circuit. An unwanted short circuit causes the fusible link to short out and act as an over current protection device. The fusible link is a metal strip that melts when too much current flows, this interrupts the circuit in which it is connected. The 110-volt AC terminals 10 are also GfCi protected. A GfCi ground fault circuit interrupter protected outlet will cause an internal breaker in the outlet to trip if it senses more than 0.5 amp variance in the electrical current, this will protect the user from electrical shock or electrocution.

FIG. 7 is the wiring diagram for the electrical system of the pickup truck tool box 1 and the same comments attributed to FIG. 6 apply. In addition FIG. 7 shows metal dividers that separate the batteries 15 from the rest of the tool box and electrical system. This is required to mitigate the possibility of arcing of the batteries 15 with any of the other electrical components or other objects such as tools as well as confining and venting any gases produced by the batteries 15.

1. An electrical energy generating and storing tool box comprising:
a top surface;
a horizontal photovoltaic panel with a top surface substantially coplanar with the top surface of the tool box; and
a power module comprising:
a direct current battery;
a battery charge controller;
a sine wave power inverter;
an externally accessible 110-volt power outlet terminal; and
an inverter switch.

2. The tool box of claim 1 wherein the toolbox is configured for installation in the bed of a pickup truck.

3. The tool box of claim 2 further comprising a 12-volt power outlet terminal and wherein the direct current battery comprises a 12-volt deep cycle gel battery.

4. The tool box of claim 3 further comprising fusible links electrically isolating the photovoltaic panel from the battery charge controller.

5. The tool box of claim 3 wherein the 110-volt power outlet terminal comprises a ground fault circuit interrupter.

6. The tool box of claim 3 further comprising a 12-volt power outlet terminal.

7. The tool box of claim 3 further comprising protective means mounted above the horizontal photovoltaic panel.

8. The tool box of claim 3 further comprising an internally accessible 110-volt power outlet.

9. The tool box of claim 3 further comprising means to physically isolates the battery from the battery charge controller, the sine wave power inverter, the 110-volt power outlet terminal, and the inverter switch.

10. The tool box of claim 3 further comprising USB charging ports.

11. The tool box of claim 9 further comprising a ventilation port in communication with the exterior of the tool box.

12. A power generating tool box comprising:
a lid;
a horizontal photovoltaic panel with a top surface substantially coplanar with the lid; and
a power module comprising:
a direct current battery;
a battery charge controller;
a sine wave power inverter;
a 110-volt power outlet terminal; and
an inverter switch;
wherein the tool box is configured for installation in the bed of a pickup truck.

13. The tool box of claim 12 further comprising a 12-volt power outlet terminal.

14. The tool box of claim 12 further comprising a 12-volt power outlet terminal and wherein the battery comprises a 12-volt deep cycle gel battery.

15. The tool box of claim 13 further comprising trickle charge terminals in electrical communication with the battery charge controller.

16. The tool box of claim 12 further comprising USB charging ports.

17. The tool box of claim 12 further comprising means for charging the battery from a power source of the pickup truck.

18. A power supply and tool storage device for a vehicle comprising:
a lid;
a horizontal photovoltaic panel with a top surface substantially coplanar with the lid; and
a power module comprising:
a direct current battery;
a battery charge controller;
a sine wave power inverter;
a 110-volt power outlet terminal;
an inverter switch; and
a connector that provides energy to the power supply and tool storage device from the vehicle.

19. The table of claim 18 further comprising USB charging ports.

20. The table of claim 18 wherein the vehicle is a pickup truck.
